(19) United States
(12) Patent Application Publication
(10) Pub. No.: US 2024/0076491 A1
(43) Pub. Date: Mar. 7, 2024

(54) NON-POROUS, BREATHABLE AND WATERPROOF TRANSPARENT ELASTOMER FILM AND METHOD FOR MANUFACTURING THE SAME

(71) Applicant: Nano and Advanced Materials Institute Limited, Hong Kong (HK)

(72) Inventors: Xianqiao LIU, Hong Kong (HK); Yik Wong NG, Hong Kong (HK); Fengyu YANG, Hong Kong (HK); Yueying CHEN, Hong Kong (HK)

(21) Appl. No.: 17/888,499

(22) Filed: Aug. 16, 2022

(51) Int. Cl. C08L 75/04; C08J 5/18

(52) U.S. Cl. CPC C08L 75/04; C08J 5/18; C08J 2375/00; C08L 2201/10; C08L 2203/16

(57) ABSTRACT

The present invention provides a non-porous, breathable and waterproof transparent elastomer film and methods for fabricating the same. The film includes a polyurethane (PU) and an amphiphilic modifier having a hydrophilic segment that acts as a channel for water vapor transmission through the film connected to a hydrophobic segment that anchors the amphiphilic modifier to a portion of the polyurethane base resin. The resultant non-porous, breathable and waterproof transparent elastomer film has a water vapor transmission rate (WVTR) or breathability of not less than 300 g/m²/24 hr according to ASTM E96B, and having at least 90% of the transmittance. The film is also resistant to liquid penetration and micro-contaminants such as bacteria and virus, making it suitable for broad applications in medical, healthcare and food packaging industries.

### FIELD OF THE INVENTION

The invention relates to the technical field of elastomer film products. More specifically, the present invention relates to a non-porous, breathable and waterproof transparent elastomer film and methods for preparing the same.

### BACKGROUND OF THE INVENTION

In recent years, the global demand for elastomer films has continued to rise, especially the continuous shift in packaging formats for flexible packaging, which is also a major factor driving the growth in demand for film materials.

Polyurethane (PU) is one of the polymer materials which has been widely used due to its excellent mechanics, acid and alkali resistance, abrasion resistance, and other properties. PU elastomer is also a widely used waterproof material and can be used to make products, such as films or artificial leather. However, most of the current PU film products on the market (e.g., waterproof membranes, foamed cottons, fibers, etc.) cannot achieve highly breathable property and high light transmittance. If a foaming agent is added to the PU material to generate micro-pores, the pore size formed in the PU material is too large to prevent water penetration, thus failing to behave as a waterproof material. Further, the micro-pores of the porous films may allow pathogenic bacteria, virus and mold to penetrate, thereby enhancing the risk of contamination.

At present, non-porous films made with special tri-block polymers have also been developed on the market. Although these films may block the penetration of microorganisms, their applications are very limited due to fixed breathability coupled with thin thickness (e.g., 15 μm), translucent appearance, poor mechanical strength, and high cost. Thus, there is a need in the art to develop novel non-porous films with improved properties, such as breathability. The present invention addresses this need.

### SUMMARY OF THE INVENTION

In accordance with one aspect of the present invention, there is provided a non-porous, breathable and waterproof transparent elastomer film. The film includes a polyurethane (PU) base resin, an amphiphilic modifier having a hydrophilic segment that acts as a channel for water vapor transmission through the film and a hydrophobic segment that is connected to the hydrophilic segment and anchors the amphiphilic modifier to a portion of the polyurethane base resin. The film has a water vapor transmission rate (WVTR) or breathability of not less than 300 g/m²/24 hr according to ASTM E96B, and having at least 90% of the transmittance.

In a first embodiment of the first aspect of the present invention, the film further includes a lubricant.

In a second embodiment of the first aspect of the present invention, the content of the base polymer ranges from 60 to 90 weight percent, the content of the amphiphilic modifier ranges from 10 to 40 weight percent, and the content of an optional chain extender ranges from 0 to 10 weight percent.

In a third embodiment of the first aspect of the present invention, the amphiphilic modifier includes at least one hydrophobic hard segment with the repeating unit of 1 to 1000 and at least one hydrophilic soft segment with the repeating unit of 1 to 1000. The at least one hydrophobic hard segment is diisocyanate. The at least one hydrophilic soft segment is polyether, such as polyethylene glycol (PEG), polypropylene glycol (PPG), polyethylene oxide (PEO), or a combination thereof.

In a fourth embodiment of the first aspect of the present invention, the thickness of the non-porous, breathable and waterproof transparent elastomer film is in a range of 1 to 40 μm or more than 0.1 mm.

In a fifth embodiment of the first aspect of the present invention, the non-porous, breathable and waterproof transparent elastomer film is fabricated by using solvent casting with an organic solvent, such as dimethylformamide (DMF), acetone, toluene, or a combination thereof.

In a sixth embodiment of the first aspect of the present invention, the substrate includes glass, metal, fabrics, cotton.

In a seventh embodiment of the second aspect of the present invention, the chain extender includes at least one polyol.

In accordance with another aspect of the present invention, there is provided a method for preparing a non-porous, breathable and waterproof transparent elastomer film comprising: dissolving a polyurethane (PU) and an amphiphilic modifier in a solvent to obtain a mixture; stirring and heating the mixture to a temperature lower than the boiling point of the solvent; casting the mixture onto a substrate and drying to form a film; and removing the film from the substrate to form the non-porous, breathable and waterproof transparent elastomer film. The removal of the film is optional if the breathable film is designed to be attached to the substrate, such as fabrics and cotton.

In a first embodiment of the second aspect of the present invention, the content of the base polymer ranges from 60 to 90 weight percent, the content of the amphiphilic modifier ranges from 10 to 40 weight percent, and the content of an optional chain extender ranges from 0 to 10 weight percent.

In a second embodiment of the second aspect of the present invention, the amphiphilic modifier includes at least one hydrophobic hard segment with the repeating unit of 1 to 1000 and at least one hydrophilic soft segment with the repeating unit of 1 to 1000. The at least one hydrophobic hard segment is diisocyanate. The at least one hydrophilic soft segment is polyether, such as polyethylene glycol (PEG), polypropylene glycol (PPG), polyethylene oxide (PEO), or a combination thereof.

In a third embodiment of the second aspect of the present invention, the solvent is an organic solvent, such as dimethylformamide (DMF), acetone, toluene, or a combination thereof.

In a fourth embodiment of the second aspect of the present invention, the chain extender includes at least one polyol.

In a fifth embodiment of the second aspect of the present invention, a mass ratio between the conventional polyurethane and the amphiphilic modifier to the solvent is 1:7.

The present invention relates to non-porous, breathable and waterproof transparent elastomer films of different thicknesses prepared by transforming common thermoplastic elastomer with an amphiphilic modifier. The resultant films are tunable and stable breathability, high transparency, and low cost.

### BRIEF DESCRIPTION OF THE DRAWINGS

Embodiments of the invention are described in more details hereinafter with reference to the drawings, in which:

FIG. 1 depicts appearance of the prepared thin PU-based films with a thickness less than 40 μm in accordance to one embodiment of the present invention;

FIG. 2A shows images of the prepared film forming compositions with different solute to solvent mass ratios; and FIG. 2B shows a top view of the prepared film forming composition with a solute to solvent mass ratio of 1:6;

FIG. 3 shows scanning electron microscope (SEM) images of non-porous PU based films with a thickness less than 40 μm in accordance to one embodiment of the present invention;

FIG. 4 depicts appearance of the prepared thick PU-based films with a thickness more than 0.1 mm in accordance to one embodiment of the present invention; and

FIG. 5 shows scanning electron microscope (SEM) images of non-porous PU based films with a thickness more than 0.1 mm in accordance to one embodiment of the present invention.

### DETAILED DESCRIPTION OF THE INVENTION

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, the term “breathable” means that the film is pervious to water vapor and gases. In other words, “breathable films” allow water vapor and gases to pass there through, but not necessarily liquids.

As used herein, the term “non-porous” means that no pores are provided on the films, which make the films are resistant to penetration of hazardous substances or non-permeable substance or materials.

As used herein, the term “thin film” refers to the films with a thickness between 1 to 40 μm. For example, the films have a thickness of 1 μm, 5 μm, 10 μm, 15 μm, 20 μm, 25 μm, 30 μm, 35 μm, or 40 μm.

As used herein, the term “thick film” refers to the films with a thickness more than 0.1 mm. For example, the films have a thickness of 0.1 mm, 0.3 mm, 0.5 mm, 0.8 mm, 1 mm, 5 mm, 10 mm, 15 mm, 20 mm, 25 mm, 30 mm, 40 mm, or 50 mm.

As used herein, the term polyurethanes” is a generic term used to describe polymers obtained by reacting isocyanates with at least one hydroxyl-containing compound, amine-containing compound, or mixture thereof.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

In order to address the objectives and needs discussed above, the present invention provides a non-porous, breathable and waterproof transparent elastomer film. The film includes a polyurethane (PU) and an amphiphilic modifier.

The base polymer and the amphiphilic modifier identified herein should meet the following requirements:
1) skin contact safe;
2) food contact safe;
3) within reasonable cost target.
   In addition to skin and food contact safety, the modifier should also be able to 1) enhance the breathability of the modified film to achieve no less than 300 g/m²/24 hr within a specific thickness range; 2) maintain no less than 90% light transmittance as compared to an unmodified control film.

The modifiers used herein have an amphiphilic structure, which includes a soft segment of a hydrophilic chain and a hard segment of a hydrophobic chain as an anchor to the polyurethane. More specifically, an aliphatic modifier includes a coupling of a hydrophilic functional group such as a hydroxyl group (—OH), carboxyl groups (—COOH), and a hydrophobic backbone. The hard segment acts as an anchor to the polyurethane (PU), and the soft segment acts as a channel for water vapor transmission and provides breathability properties.

In one embodiment, the hydrophilic soft segment is polyether, such as PEG, PPG and PEO. The hydrophobic hard segment is di-isocyanate with compatibility with the base PU, serving as an anchor. Based on these criteria, two modifiers for PU were shortlisted in Table 1.

TABLE 1
Modifiers for non-porous PU film

| Modi- | |
|---|---|
| fier | Chemical Structure |
| Des- mo- pan 6580A | 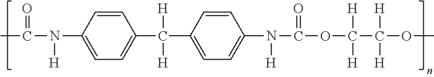 |
| Teco- philic TG500 | 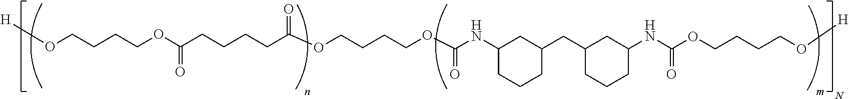 |

In one embodiment of the present invention, the prepared films can be divided into two types, one is a thin film with a thickness between 1 to 40 μm, and another one is a thick film with a thickness more than 0.1 mm.

In one embodiment of the present invention, both thin films and thick films have a water vapor transmission rate (WVTR) or breathability of not less than 300 g/m²/24 hr according to ASTM E96B, preferably higher than 400 g/m²/24 hr, more preferably higher than 600 g/m²/24 hr.

In one embodiment of the present invention, the films are colorless and/or transparent, allowing effective penetration of ultraviolet and visible light. In particular, the target light transmittance is no less than 90% as compared to the unmodified control films. For instance, at least 90%, at least 91%, at least 92%, at least 93%, at least 94%, at least 95%, at least 96%, at least 97%, at least 98%, or at least 99%, or 100%.

In accordance with a second aspect of the present invention, there is provided a method for preparing a non-porous, breathable and waterproof transparent elastomer film, the method includes dissolving a conventional polyurethane (PU) and an amphiphilic modifier in a solvent to obtain a mixture; vigorously stirring the first mixture and heating the mixture to a temperature lower than the boiling point of the solvent; and casting the mixture onto the substrate and drying to form the non-porous, breathable and waterproof transparent elastomer film coated substrate followed by removal from the substrate to form a freestanding film. The thickness of the films was adjusted by tuning the gap distance between the casting machine and the substrate surface.

It should be noted that the step of vigorously stirring must be provided to prevent the agglomeration of the mixture, and the step of heating should also be provided to enhance the dissolving rate, yet the temperature should not exceed the boiling point of the solvent.

In one embodiment of the present invention, the casting process may be carried out by using a solution casting machine with a stretching function.

In one embodiment of the present invention, the solvent is an organic solvent, such as dimethylformamide (DMF), acetone, toluene, or a combination thereof. In addition to the above solvents, other solvents can also be used, as long as the solvent is capable of dissolving all of the base polymer and the aliphatic modifier.

The description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated.

One skilled in the art would readily appreciate that different functions discussed herein may be performed in a different order and/or concurrently with each other. Many modifications and variations will be apparent to the practitioner skilled in the art. Furthermore, if desired, one or more of the embodiments described herein may be optional or may be combined. Other aspects and advantages of the present invention will be apparent to those skilled in the art from a review of the present application.

### EXAMPLES

### Example 1—Fabrication of Thin PU Based Non-Porous Film

Elastollan 1185A10 was chosen to be the base resin of PU, as it is transparent, mechanically strong, skin and food contact safe. Desmopan 6580A MVT or Tecophilic TG500 were chosen for modifying PU. Since these two modifiers have excellent water vapor transportation properties, they were expected to improve the breathability of the films significantly.

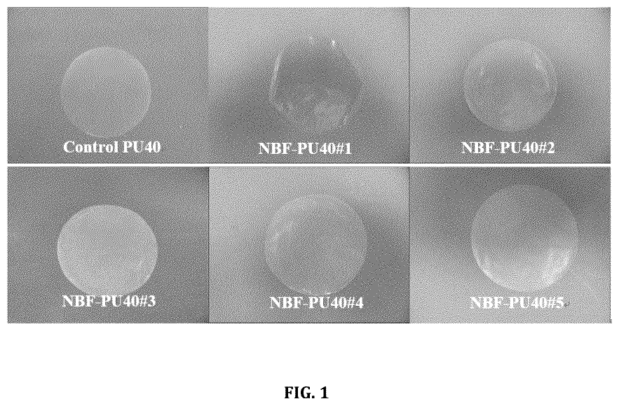

Five thin PU based non-porous films were prepared by solvent casting method via dissolving PU base resin and an amphiphilic modifier in dimethylformamide (DMF). Different film forming compositions in accordance with the present invention were shown in Table 2. The as-prepared thin PU based non-porous films were shown in FIG. 1. All formulations can form films with thicknesses less than 40 μm.

TABLE 2
Formulations of thin PU based non-porous films.

| | Polyurethane (PU) | Amphiphilic | Amphiphilic | Solute to Solvent |
|---|---|---|---|---|
| | (1185A10) | modifier (6580A) | modifier (TG500) | (DMF) mass ratio |
| NBF-PU40 #1 | 90% | 10% | — | 1:7 |
| NBF-PU40 #2 | 80% | 20% | — | 1:7 |
| NBF-PU40 #3 | 70% | 30% | — | 1:7 |
| NBF-PU40 #4 | 60% | 40% | — | 1:7 |
| NBF-PU40 #5 | 80% | — | 20% | 1:7 |

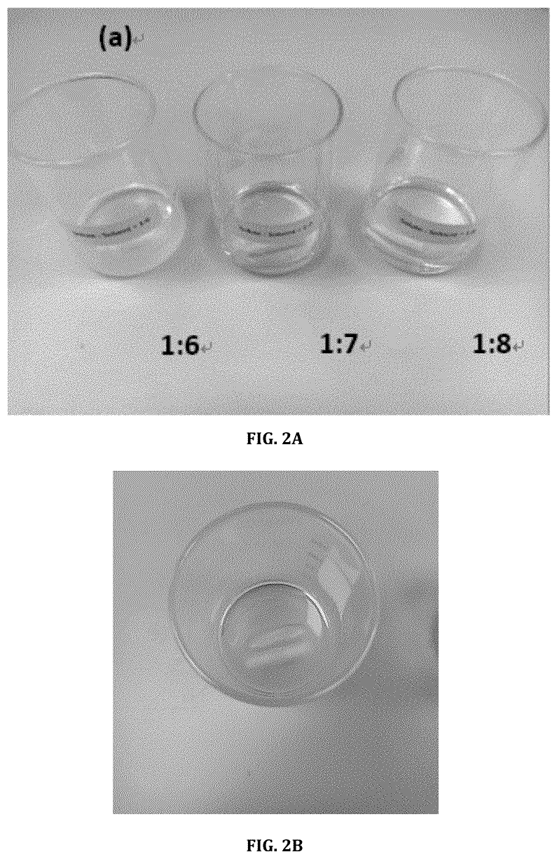

Referring to Table 2, the solute to solvent mass ratio was determined by considering completion of dissolution of solute and the viscosity of the solution. The samples with different solute to solvent mass ratio were shown in FIG. 2A-2B. With several trials, it was found that the optimal mass ratio between the solute (PU plus modifier) to solvent (DMF) was 1:7. As shown in FIG. 2A and FIG. 2B, when the addition of solvent was less than the optimal ratio, for example 1:6, the solute was not dissolved completely and led to the waste of the solute. When the addition of solvent was more than the optimal ratio, for example 1:8, the viscosity of the solution was too high, which resulted in the difficulty in adjusting the thickness of the film as the solution was more likely to spread during the drying process. On the other hand, the more the solvent is added, the higher the cost and the longer the time for drying process it requires, which is not appealing economically.

### Example 2—Analysis of Appearance of the Thin Film

To ensure the as-prepared thin films are non-porous, SEM imaging were conducted.

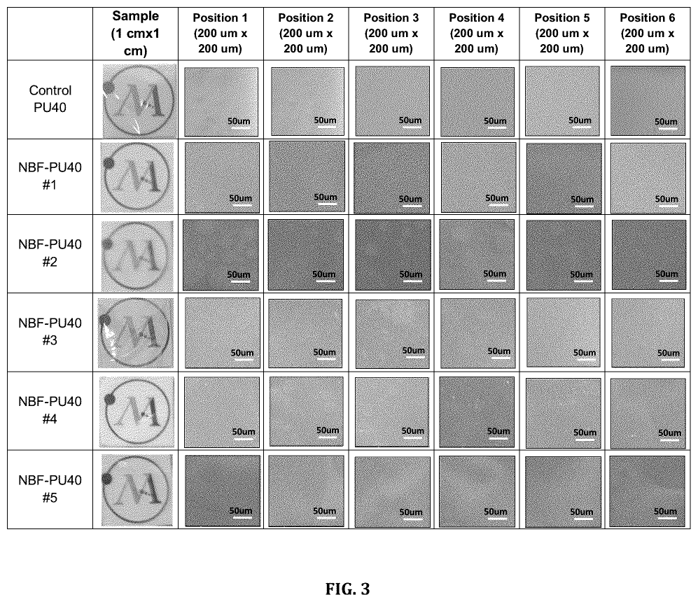

Six different areas of the films (200 μm×200 μm for each) were selected and no obvious pore was founded. The SEM images of non-porous PU based films with a thickness less than 40 μm were shown in FIG. 3. From the SEM images, it could be seen that no pore with a diameter larger than 1 μm was observed.

### Example 3—Transmittance of the Thin Film

The light transmittance of the prepared thin films was measured in comparison with the unmodified control films (e.g., PU) according to industrial standard test methods (e.g., ASTM E 96B).

The light transmittance of the as-prepared thin PU based films has been tested and compared with the control films to ensure the light transmittance of the films can retain no less than 90% of the control films. The results of non-porous PU based films were shown in Table 3.

TABLE 3
Light transmittance of non-porous PU based films with a thickness less than 40 μm

| | PU base | | | | Light | Light trans. |
|---|---|---|---|---|---|---|
| | resin | Modifier | Modifier | Thickness | transmittance | retention |
| | (1185A10) | (6580A) | (TG500) | (μm) | (%) | (%) |
| Control PU40 | 100% | — | — | 40 ± 6 | 91.13 ± 0.47 | — |
| | | | | (n = 3) | (n = 3) | |
| NBF-PU40#1 | 90% | 10% | — | 26 ± 1 | 90.98 ± 0.44 | 99.83 |
| | | | | (n = 3) | (n = 3) | |
| NBF-PU40#2 | 80% | 20% | — | 30 ± 0 | 91.22 ± 0.27 | 100 |
| | | | | (n = 3) | (n = 3) | |
| NBF-PU40#3 | 70% | 30% | — | 29 ± 2 | 91.24 ± 0.48 | 100 |
| | | | | (n = 3) | (n = 3) | |
| NBF-PU40#4 | 60% | 40% | — | 28 ± 4 | 90.38 ± 0.10 | 99.17 |
| | | | | (n = 3) | (n = 3) | |
| NBF-PU40#5 | 80% | — | 20% | 29 ± 2 | 92.36 ± 0.12 | 100 |
| | | | | (n = 3) | (n = 3) | |

From Table 3, it was found that the light transmittance retention for thin non-porous PU based films was more than 90% when comparing to the corresponding control films, indicating that the addition of the modifiers would not have big impact to the light transmittance of the films.

### Example 4—Breathability of the Thin Film

Apart from the retention of light transmittance, the breathability of the as-developed thin PU based films were tested according to the industrial standard ASTM E96 method B at the temperature of 23° C. and 50% relative humidity in the testing chamber. The breathability was represented by the Water Vapor Transmission Rate (WVTR) with the unit of g/m²/24 hr.

In addition to in house breathability test, the thin film samples have also been sent to an external lab (SGS-CSTC Standards Technical Services Co., Ltd. Guangzhou Branch) for the breathability test according to ASTM E96 method B. The results were shown in Table 4.

TABLE 4
Breathability of non-porous PU based films with a thickness less than 40 μm

| | | | | | In house | External lab |
|---|---|---|---|---|---|---|
| | PU resin | Modifier | Modifier | Thickness | WVTR | WVTR |
| | (1185A10) | (6580A) | (TG500) | (μm) | (g/m²/24 hr) | (g/m²/24 hr) |
| Control PU40 | 100% | — | — | 35 ± 11 | 281 ± 12 | 367 |
| | | | | (n = 3) | (n = 3) | (n = 3) |
| NBF-PU40#1 | 90% | 10% | — | 26 ± 1 | 321 ± 38 | 355 |
| | | | | (n = 3) | (n = 3) | (n = 3) |
| NBF-PU40#2 | 80% | 20% | — | 30 ± 0 | 372 ± 23 | 371 |
| | | | | (n = 3) | (n = 3) | (n = 3) |
| NBF-PU40#3 | 70% | 30% | — | 29 ± 2 | 449 ± 51 | 428 |
| | | | | (n = 3) | (n = 3) | (n = 3) |
| NBF-PU40#4 | 60% | 40% | — | 28 ± 4 | 699 ± 59 | 674 |
| | | | | (n = 3) | (n = 3) | (n = 3) |
| NBF-PU40#5 | 80% | — | 20% | 29 ± 2 | 563 ± 23 | Not tested |
| | | | | (n = 3) | (n = 3) | |

From Table 4, in house breathability test results showed that all thin films had a water vapor transmission rate (WVTR) or breathability of not less than 300 g/m²/24 hr when comparing to the corresponding control films, preferably higher than 400 g/m²/24 hr (NBF-PU40#3), more preferably higher than 600 g/m²/24 hr (NBF-PU40#4). This conclusion was also verified by the external lab test.

Besides, it was found that the more the modifier added, the higher the breathability the NBF was, implying the breathability is tunable and customizable according to industrial applications in the future.

### Example 5—Cost

The material cost for thin PU based non-porous films has been evaluated to ensure it would not exceed 4.0 HKD/m². The density of PU and PU based films are about 1200 kg/m³. The material cost is calculated by following equation:

Material cost(HKD/m²)=[Σcost of component(HKD/kg)*percentage of component]*density(kg/m³)*(target thickness(m))

Taking NBF-PU40#1 as an example, it is given that:
Cost of PU base resin (1185A10): 30.00 HKD/kg
Cost of modifier (6580A): 40.00 HKD/kg
Density of NBF-PU40#1: 1200 kg/m³
   The material cost of NBF-PU40#1:

cost=(90%*30+10%*40)*1200*(40*10⁻⁶)=1.49 HKD/m²

By using the equation above, the material cost for all thin PU based films was calculated and showed in Table 5.

TABLE 5
Material cost of thin PU based films

| | PU base | Unit | | Unit | | Unit | Material |
|---|---|---|---|---|---|---|---|
| | resin | price | Modifier | price | Modifier | price | cost |
| | (1185A10) | (HKD/kg) | (6580A) | (HKD/kg) | (TG500) | (HKD/kg) | (HKD/m²) |
| Control | 100% | 30.00 | — | — | — | — | 1.44 |
| PU40 | | | | | | | |
| NBF- | 90% | 30.00 | 10% | 40.00 | — | — | 1.49 |
| PU40#1 | | | | | | | |
| NBF- | 80% | 30.00 | 20% | 40.00 | — | — | 1.54 |
| PU40#2 | | | | | | | |
| NBF- | 70% | 30.00 | 30% | 40.00 | — | — | 1.59 |
| PU40#3 | | | | | | | |
| NBF- | 60% | 30.00 | 40% | 40.00 | — | — | 1.63 |
| PU40#4 | | | | | | | |
| NBF- | 80% | 30.00 | — | — | 20% | 530.00 | 6.24 |
| PU40#5 | | | | | | | |

Note:
The density of non-porous film is 1200 kg/m³, thickness 40 μm for calculation

Referring to Table 5, it was found that most of the thin PU based films, except NBF-PU40#5, have met the target that the material cost did not exceed 4.00 HKD/m².

### Example 6—Fabrication of Thick PU based Non-Porous Film

Elastollan 1185A10 was chosen to be the base resin of PU, as it is transparent, mechanically strong, skin and food contact safe. Desmopan 6580A MVT was chosen for modifying PU because it has excellent water vapor transportation property and is expected to improve the breathability of the films significantly.

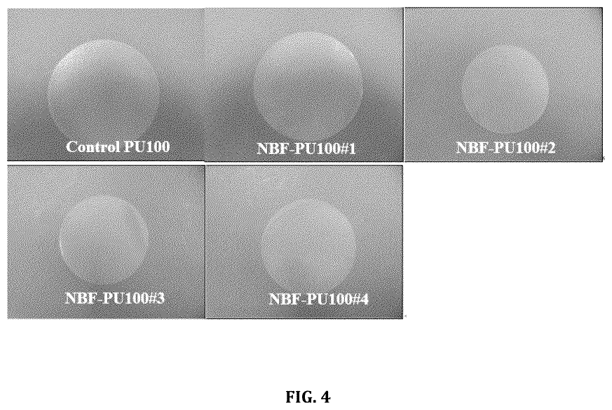

Four thick PU based non-porous films were prepared by solvent casting method via dissolving PU base resin and an amphiphilic modifier in dimethylformamide (DMF). Different film forming compositions in accordance with the present invention are shown in Table 6. The as-prepared thin PU based non-porous films were shown in FIG. 4. All formulations can form films with thicknesses more than 0.1 mm.

TABLE 6
Formulations of thick PU based non-porous films.

| | PU base resin | Modifier | Solute to Solvent |
|---|---|---|---|
| | (1185A10) | (6580A) | (DMF) mass ratio |
| NBF-PU100 #1 | 90% | 10% | 1:7 |
| NBF-PU100 #2 | 80% | 20% | 1:7 |
| NBF-PU100 #3 | 70% | 30% | 1:7 |
| NBF-PU100 #4 | 60% | 40% | 1:7 |

Referring to Table 6, the solute to solvent mass ratio was determined by considering completion of dissolution of solute and the viscosity of the solution. With several trials, it was found that the optimal mass ratio between the solute (PU plus modifier) to solvent (DMF) was 1:7.

### Example 7—Analysis of Appearance of the Thick Film

To ensure the as-prepared thick films are non-porous, SEM imaging were conducted.

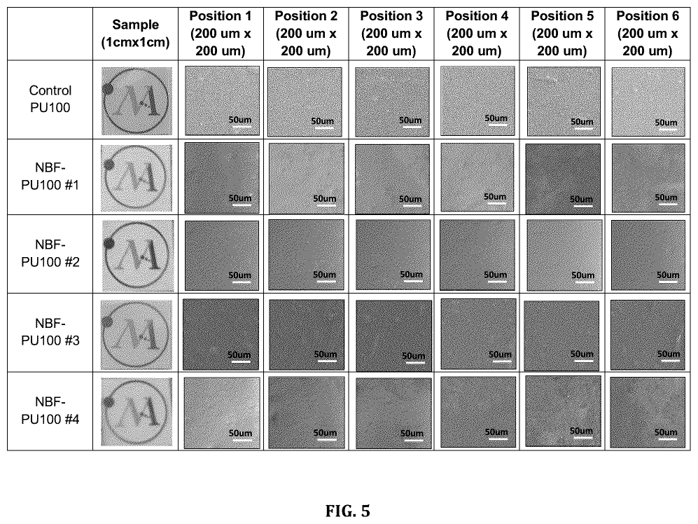

Six different areas of the films (200 μm×200 μm for each) were selected and no obvious pore was founded. The SEM images of non-porous PU based films with a thickness more than 0.1 mm were shown in FIG. 5. From the SEM images, it could be seen that no pore with diameter larger than 1 μm was observed.

### Example 8—Transmittance of the Thick Film

The light transmittance of the prepared thick films was measured in comparison with the unmodified control films (e.g., PU) according to industrial standard test methods (e.g., ASTM E 96B).

The light transmittance of the as-prepared thick PU based films has been tested and compared with the control films to ensure the light transmittance of the films can retain no less than 90% of the control films. The results of non-porous PU based films were shown in Table 7.

TABLE 7
Light transmittance of non-porous PU based
films with a thickness more than 0.1 mm

| | | | | | Light |
|---|---|---|---|---|---|
| | PU base | | | Light | trans. |
| | resin | Modifier | Thickness | transmittance | retention |
| | (1185A10) | (6580A) | (μm) | (%) | (%) |
| Control | 100% | — | 102 ± 4 | 90.50 ± 0.72 | N/A |
| PU100 | | | (n = 3) | (n = 3) | |
| NBF- | 90% | 10% | 122 ± 9 | 89.67 ± 1.44 | 99.09 |
| PU100#1 | | | (n = 3) | (n = 3) | |
| NBF- | 80% | 20% | 107 ± 3 | 90.25 ± 1.64 | 99.72 |
| PU100#2 | | | (n = 3) | (n = 3) | |
| NBF- | 70% | 30% | 125 ± 9 | 91.03 ± 0.41 | 100 |
| PU100#3 | | | (n = 3) | (n = 3) | |
| NBF- | 60% | 40% | 118 ± 2 | 88.61 ± 1.23 | 97.91 |
| PU100#4 | | | (n = 3) | (n = 3) | |

From Table 7, it was found that the light transmittance retention for thick non-porous PU based films was more than 90% when comparing to the corresponding control films, which indicated the addition of the modifiers would not have big impact to the light transmittance of the films.

### Example 9—Breathability of the Thick Film

Apart from the retention of light transmittance, the breathability of the as-developed thick PU based films were tested according to the industrial standard ASTM E96 method B at the temperature of 23° C. and 50% relative humidity in the testing chamber. The breathability was represented by the Water Vapor Transmission Rate (WVTR) with the unit of g/m²/24 hr.

In addition to in house breathability test, the thick film samples have also been sent to an external lab (SGS-CSTC Standards Technical Services Co., Ltd. Guangzhou Branch) for the breathability test according to ASTM E96 method B. The results were shown in Table 8.

TABLE 8
Breathability of non-porous PU based films with a thickness more than 0.1 mm

| | | | | | External |
|---|---|---|---|---|---|
| | PU base resin | Modifier | Thickness | In house WVTR | lab WVTR |
| | (1185A10) | (6580A) | (μm) | (g/m²/24 hr) | (g/m²/24hr) |
| Control PU100 | 100% | — | 102 ± 4 | 135 ± 6 | 128 |
| | | | (n = 3) | (n = 3) | (n = 3) |
| NBF-PU100#1 | 90% | 10% | 103 ± 4 | 185 ± 6 | 129 |
| | | | (n = 3) | (n = 3) | (n = 3) |
| NBF-PU100#2 | 80% | 20% | 107 ± 7 | 240 ± 17 | 208 |
| | | | (n = 3) | (n = 3) | (n = 3) |
| NBF-PU100#3 | 70% | 30% | 100 ± 6 | 350 ± 50 | 241 |
| | | | (n = 3) | (n = 3) | (n = 3) |
| NBF-PU100#4 | 60% | 40% | 105 ± 4 | 383 ± 13 | 323 |
| | | | (n = 3) | (n = 3) | (n = 3) |

From Table 8, in house breathability test results showed that all thin films had a water vapor transmission rate (WVTR) or breathability of not less than 100 g/m²/24 hr when comparing to the corresponding control films, preferably higher than 200 g/m²/24 hr (NBF-PU100#2), more preferably higher than 300 g/m²/24 hr (NBF-PU100#3 and NBF-PU100#4). This conclusion was also verified by the external lab. The breathability of NBF-PU100#4 can achieve more than 300 g/m²/24 hr for both in house and external tests.

Besides, it was found that the more the modifier added, the higher the breathability the NBF was, implying the breathability is tunable and customizable according to industrial applications in the future.

### Example 10—Cost

The material cost for thick PU based non-porous films has been evaluated to ensure it would not exceed 10.0 HKD/m². The density of PU and PU based films are about 1200 kg/m³. The material cost is calculated by following equation:

Material cost(HKD/m²)=[Σcost of component(HKD/kg)*percentage of component]*density(kg/m³)*(target thickness(m))

Taking NBF-PU100#4 as an example, it is given that:
Cost of PU base resin (1185A10): 30.00 HKD/kg
Cost of modifier (6580A): 40.00 HKD/kg
Density of NBF-PU40#1: 1200 kg/m³
   The material cost of NBF-PU100#4:

cost=(60%*30+40%*40)*1200*(100*10⁻⁶)=4.08 HKD/m²

By using the equation above, the material cost for all thick PU based films was calculated and showed in Table 9.

TABLE 9
Material cost of thick PU based films

| | PU base | | | | |
|---|---|---|---|---|---|
| | resin | Unit price | Modifier | Unit price | Material cost |
| | (1185A10) | (HKD/kg) | (6580A) | (HKD/kg) | (HKD/m²) |
| Control | 100% | 30.00 | — | — | 3.60 |
| PU100 | | | | | |
| NBF- | 90% | 30.00 | 10% | 40.00 | 3.72 |
| PU100#1 | | | | | |
| NBF- | 80% | 30.00 | 20% | 40.00 | 3.84 |
| PU100#2 | | | | | |
| NBF- | 70% | 30.00 | 30% | 40.00 | 3.96 |
| PU100#3 | | | | | |
| NBF- | 60% | 30.00 | 40% | 40.00 | 4.08 |
| PU100#4 | | | | | |

Note:
The density of non-porous film is 1200 kg/m³, thickness 100 μm for calculation

Referring to Table 9, it was found that all the thin PU based films have met the target that the material cost did not exceed 10.00 HKD/m².

It will be appreciated by those skilled in the art, in view of these teachings, that alternative embodiments may be implemented without deviating from the spirit or scope of the invention, as set forth in the appended claims. This invention is to be limited only by the following claims, which include all such embodiments and modifications when viewed in conjunction with the above specification and accompanying drawings.

### INDUSTRIAL APPLICABILITY

The present invention relates to non-porous, breathable and waterproof transparent elastomer films of different thicknesses by transforming common thermoplastic elastomer with an amphiphilic modifier. The resultant films are tunable and stable breathability, high transparency, and low cost. They are also resistant to liquid penetration and micro-contaminants such as bacteria and virus, making them suitable for broad applications in medical, healthcare and food packaging industries.

1. A non-porous, breathable and waterproof transparent elastomer film, comprising:
a polyurethane (PU) base resin;
an amphiphilic modifier having a hydrophilic segment that acts as a channel for water vapor transmission through the film connected to a hydrophobic segment that anchors the amphiphilic modifier to a portion of the polyurethane base resin; and
wherein the non-porous, breathable and waterproof transparent elastomer film has a water vapor transmission rate (WVTR) of at least 300 g/m²/24 hr, and wherein the film has at least 90% transmittance.

2. The non-porous, breathable and waterproof transparent elastomer film according to claim 1, wherein the polyurethane has a content ranging from 60 to 90 weight percent, the amphiphilic modifier has a content ranging from 10 to 40 weight percent, and an optional chain extender has a content ranging from 0 to 10 weight percent.

3. The non-porous, breathable and waterproof transparent elastomer film according to claim 1, wherein the amphiphilic modifier comprises at least one hydrophobic hard segment with a repeating unit of 1 to 1000 and at least one hydrophilic soft segment with a repeating unit of 1 to 1000.

4. The non-porous, breathable and waterproof transparent elastomer film according to claim 3, wherein the at least one hydrophilic soft segment comprises polyether, and the at least one hydrophobic hard segment comprises diisocyanate.

5. The non-porous, breathable and waterproof transparent elastomer film according to claim 4, wherein the polyether comprises polyethylene glycol (PEG), polypropylene glycol (PPG), polyethylene oxide (PEO), or a combination thereof.

6. The non-porous, breathable and waterproof transparent elastomer film according to claim 1, wherein thickness of the non-porous, breathable and waterproof transparent elastomer film is in a range of 1 to 40 μm or more than 0.1 mm.

7. The non-porous, breathable and waterproof transparent elastomer film according to claim 1, wherein the non-porous, breathable and waterproof transparent elastomer film is fabricated using solvent casting with an organic solvent.

8. The non-porous, breathable and waterproof transparent elastomer film according to claim 7, wherein the organic solvent comprises dimethylformamide (DMF), acetone, toluene, or a combination thereof.

9. The non-porous, breathable and waterproof transparent elastomer film according to claim 1, further comprising a chain extender comprising at least one polyol.

10. A method for preparing a non-porous, breathable and waterproof transparent elastomer film of claim 1, wherein the method comprises:
dissolving a polyurethane (PU) and an amphiphilic modifier in a solvent to obtain a first mixture;
stirring and heating the first mixture to a temperature lower than the boiling point of the solvent;
casting the mixture onto a substrate and drying to form a film;
removing the film from the substrate to form the non-porous, breathable and waterproof transparent elastomer film;
skipping the removal of the film from substrate if the film is designed to be attached on the substrate.

11. The method according to claim 10, wherein the polyurethane has a content ranging from 60 to 90 weight percent and the amphiphilic modifier has a content ranging from 10 to 40 weight percent.

12. The method according to claim 10, wherein the amphiphilic modifier comprises at least one hydrophobic hard segment with a repeating unit of 1 to 1000 and at least one hydrophilic soft segment with a repeating unit of 1 to 1000.

13. The method according to claim 12, wherein the at least one hydrophilic soft segment comprises polyether, and the at least one hydrophobic hard segment comprises diisocyanate.

14. The method according to claim 13, wherein the polyether comprises polyethylene glycol (PEG), polypropylene glycol (PPG), polyethylene oxide (PEO), or a combination thereof.

15. The method according to claim 10, wherein the solvent is an organic solvent comprising dimethylformamide (DMF), acetone, toluene, or a combination thereof.

16. The method according to claim 10, further comprising a chain extender including at least one polyol.

17. The method according to claim 10, wherein a mass ratio between the polyurethane and the amphiphilic modifier to the solvent is 1:7.
